(19) United States
(12) Patent Application Publication
(10) Pub. No.: US 2015/0206100 A1
(43) Pub. Date: Jul. 23, 2015

(54) CROWDSOURCED MANAGEMENT SYSTEM

(71) Applicant: WIKISTRAT LTD., Tel-Aviv (IL)

(72) Inventors: Joel Zamel, Tel Aviv (IL); Daniel Green, Tel Aviv (IL); Elad Schaffer, Tel Aviv (IL); Aviram Gabay, Tel Aviv (IL)

(21) Appl. No.: 14/423,781

(22) PCT Filed: Aug. 28, 2013
(86) PCT No.: PCT/IL13/00067

§ 371 Date: Feb. 25, 2015

Related U.S. Application Data
(60) Provisional application No. 61/693,790, filed on Aug. 28, 2012.
(60) Provisional application No. 61/704,508, filed on Sep. 23, 2012.

(51) Int. Cl. G06Q 10/10

(52) U.S. Cl. CPC G06Q 10/10

(57) ABSTRACT

The present invention discloses a crowdsourced management system for development of a set of content documents, comprising: (a) plurality of computers communicating over a network; (b) a computer readable medium comprising one or more functional modules including (i) a database for storing clients and analysts data; (ii) a registration module for registering clients and user analysts in said database; and (iii) an automatic recruitment module for contacting said user analyst

### FIELD OF THE INVENTION

The present invention generally relates to a system for management of crowdsourced teams of user analysts for producing targeted documents.

### BACKGROUND

For many years, research, analysis, forecasting and production of content in general were conducted in small silos, or by experts scattered around the world. These experts opinions were published using traditional media, and rarely upon individual request. In the case where an individual request is produced, it is almost impossible to gather experts from different locations around the world in order to produce a joint document in a reasonable time and at a reasonable price.

WO2011/018787 (refers hereinafter as 787′) shows a system for collaborative development of competition. The method reveals steps of sharing the files and commenting, however, 787′ does not reveal expert input and an advanced grading system for the document grading.

There is therefore a long unmet need for a simple, easy to use system, which is an improvement on the currently available management systems for producing targeted documents.

### SUMMARY OF THE INVENTION

It is an object of the present invention to disclose a crowdsourced management system for development of a set of content documents, said system comprising: (a) a plurality of computers communicating over a network; (b) a computer readable medium comprising one or more functional modules including (i) a database for storing clients' and analysts' data; (ii) a registration module for registering clients and user analysts in said database; and (iii) an automatic recruitment module for contacting said user analysts; wherein the modules are distributed among said computers and said modules are configured to execute a method for collaboratively developing said documents.

It is a further object of the present invention to disclose the system as defined above, wherein said modules execute said method comprising steps of: displaying on said computers pre-defined templates that assist corresponding user analysts of each of said computers to formulate candidate documents on said corresponding computers; displaying on each of said computers all the candidate documents formulated on all said computers, each said formulated document being displayed on a separate page on each of said computers; and receiving, on said computers, information from said corresponding user analysts of said computers, said information is for performing at least one of commenting on a document displayed on the corresponding computer and amending a document displayed on said corresponding computer; wherein said information received on one of said computers affects an associated document on all said computers; accumulating scores for each of the documents based upon said comments; and displaying summary information on said computers reflecting the scores, said scores ranking said candidate documents.

It is a further object of the present invention to disclose the system as defined above, wherein said database is adapted for storing said analysts' metadata.

It is a further object of the present invention to disclose the system as defined above, wherein the analysts metadata is selected from a group consisting of location, academic qualifications, contact information (address, phone, e-mail and the like) specialization/domains of expertise, analyst rank, past participation, past achievements by category, accuracy, innovation, current professional association, employment history (including conflict of interest), contribution type, quantity of contributions, security clearance, levels of access to information, financial earnings, rating of analysis, availability or any combination thereof.

It is a further object of the present invention to disclose the system as defined above, wherein said computer readable medium further comprises a ranking module adapted for ranking said analysts according to predetermined variables, updated during and after specific engagement.

It is a further object of the present invention to disclose the system as defined above, wherein said recruitment module is adapted for automatically inviting said analysts to an engagement and track whether they accept or decline, and sending additional invitations to replace those who decline.

It is a further object of the present invention to disclose the system as defined above, wherein said registration and recruitment modules are adapted for automatically processing potential new analysts either by lead (emailing them) or by application, and then registering them in the system based on crowdsourcing.

It is a further object of the present invention to disclose the system as defined above, wherein said computer readable medium further comprises an engagement space creation module configured to take parameters for the engagement from a client to create the necessary content placeholders, link them together and set up security permissions. Thereby, as said analysts create new content, they can ensure that new information is stored into the correct locations automatically.

It is a further object of the present invention to disclose the system as defined above, wherein said computer readable medium further comprises an analyst selection module adapted for functionally sorting user analysts into optimal groups or team configurations.

It is a further object of the present invention to disclose the system as defined above, wherein said analyst selection module is further configured to propose alternative backup teams, prioritized lists of teams or any other conventional alternative combination.

It is a further object of the present invention to disclose the system as defined above, wherein said selecting of user analysts is based on client requests (engagement attributes), analyst metadata, client request (engagement attributes) matched against analyst metadata, and any combination thereof.

It is a further object of the present invention to disclose the system as defined above, wherein said analyst selection module is configured to receive sets of desired capabilities, skillsets, budget, number of analysts required and their ranks, and yields an optimal team composition for an engagement.

It is a further object of the present invention to disclose the system as defined above, wherein said computer readable medium further comprises a tracking module for storing and monitoring analyst contributions by type, quantity, and quality.

It is a further object of the present invention to disclose the system as defined above, wherein said tracking module further configured for monitoring how both said clients and said analysts interact and/or rating the contributions for determining the quality and relevance of said analysts' participation.

It is a further object of the present invention to disclose the system as defined above, wherein said system additionally comprises a metadata store.

It is a further object of the present invention to disclose the system as defined above, wherein said system additionally comprises a gamification/reward/recognition module configured to process said monitored participation data and to provide game mechanics to incentivize and mobilize said user analyst.

It is a further object of the present invention to disclose the system as defined above, wherein said game mechanics comprises accumulation of points for said analyst interactions.

It is a further object of the present invention to disclose the system as defined above, wherein said interactions are selected from a group consisting of editing pages, commenting, creating pages, recruitment of analysts, completing projects, securing clients, and getting media mentions for the network.

It is a further object of the present invention to disclose the system as defined above, wherein said game mechanics further comprise a marker of achievements for indicating passing a specific point and/or contribution and/or milestone.

It is a further object of the present invention to disclose the system as defined above, wherein said gamification/reward/recognition module is configured to display said accumulating points and/or said marker of achievements in profiles, scoreboards and leader board formats via boards by group, boards by rank and/or boards by level and any other conventional displaying system.

It is a further object of the present invention to disclose the system as defined above, wherein said gamification/reward/recognition module is further configured to notify said analysts about their achievements by internet computer network, intra net computer network, email, SMS, and any other conventional messaging system.

It is a further object of the present invention to disclose the system as defined above, wherein said gamification/reward/recognition module is further configured for displaying a “flash on screen” encouragement on said analysts screens in live response to their contribution achievements.

It is a further object of the present invention to disclose the system as defined above, wherein said gamification/reward/recognition module is further configured to enable said analysts to compete in competitions both core and ancillary to their engagements by exchanging work in return for the opportunity to earn and/or win cash prizes and/or any other conventional rewards.

It is a further object of the present invention to disclose the system as defined above, wherein said gamification/reward/recognition module further configured to enable a rapid mobilization and incentivization of the contribution of said analysts.

It is a further object of the present invention to disclose the system as defined above, wherein said tracking module is linked to said metadata store and said gamification/reward/recognition module.

It is a further object of the present invention to disclose the system as defined above, wherein said system further comprises a reporting module adapted for any of a group consisting of aggregation, charting, and collation of data from other modules of said system into reports.

It is a further object of the present invention to disclose the system as defined above, wherein said reports are selected from a group consisting of (a) timely reports on levels and frequency of participation by all said user analysts, user analyst groups and individual user analysts; (b) timely reports on levels and frequency of participation within specific engagements, pages, and page groups; (c) red flagging of user analysts who don't login, contribute, or who fail to conduct certain actions; (d) failed login attempts; (e) highest rating viewing/editing user analysts and (f) multi-IP user analyst logins.

It is a further object of the present invention to disclose the system as defined above, wherein said computer readable medium further comprises a module adapted for iteratively storing analyst created content in real time.

It is a further object of the present invention to disclose the system as defined above, wherein said computer readable medium further comprises a module adapted for iteratively merging analyst created content in real time.

It is a further object of the present invention to disclose the system as defined above, wherein said computer readable medium further comprises an editing module adapted for iteratively editing said set of content documents in real time.

It is a further object of the present invention to disclose the system as defined above, wherein said system further comprises a payment module for transmitting payment and/or any other physical item to said analysts, when earned, by multiple payment services, on an automatic, semi-automatic and manual basis.

It is a further object of the present invention to disclose the system as defined above, wherein said computer readable medium further contains instructions for the implementation of at least one algorithm selected from a group consisting of general combinatorial algorithms, graph algorithms, graph drawing, network theory, routing, and search.

It is a further object of the present invention to disclose the system as defined above, wherein said at least one algorithm is selected from the group consisting of Brent's algorithm for finding cycles in iterations using only two iterators, Floyd's cycle-finding algorithm for finding cycles in iterations, Gale-Shapley algorithm for matching pseudorandom number generators (uniformly distributed), Blum Blum Shub algorithm, lagged Fibonacci generator, linear congruential generator, and Mersenne twister.

It is a further object of the present invention to disclose the system as defined above, wherein said computer readable medium further comprises a remuneration module adapted for calculating a user analyst's rewards.

It is a further object of the present invention to disclose the system as defined above, wherein said user analyst's rewards are selected from a group consisting of: virtual points, badges and virtual achievements, physical prizes, cash prizes, revenue split, royalties, commission and any other conventional rewards known in the art.

It is a further object of the present invention to disclose the system as defined above, wherein said rewards are calculated using multiple factors and complexities.

It is a further object of the present invention to disclose the system as defined above, wherein said factors are selected from a group consisting of: analyst rank, analyst past performance evaluation, analyst accumulated number of points, or point combinations, number of hours conducted by the analyst, number of analytic modules the analyst participates in, complexity of analytic modules the analyst participates in, number of direct client interactions required between the analyst and the client.

It is a further object of the present invention to disclose the system as defined above, wherein said computer readable medium further comprises a pricing module adapted for determining the price for client engagements.

It is a further object of the present invention to disclose the system as defined above, additionally comprising a module for rewarding either one of said clients, said analysts/users with a reward selected from a group comprising of: points, ranks, levels, non-monetary rewards (access to additional content), monetary rewards (prize pool), and a combination thereof.

It is a further object of the present invention to disclose the system as defined above, in communication with different systems as described above.

It is a further object of the present invention to disclose the system as defined above, wherein said at least one system alerts another system on detection of a relevant event.

It is a further object of the invention to disclose a first system as defined above wherein the first system is in communication with at least one other second system contextually distinguishable from the aforementioned first system; the second system is architecturally congruent with the aforementioned first system.

It is a further object of the present invention to disclose the system as defined above, wherein said system additionally comprising a simulation/project creation module.

It is a still an object of the present invention to disclose the system as defined above, wherein said price is configured to be determined using multiple factors and complexities.

It is lastly an object of the present invention to disclose the system as defined above, wherein said factors are selected from a group consisting of: number of analysts participating, rank of each participating analyst, number and quality of external analysts requested, number of hours required of each analyst in the project, number of analytic modules requested, length of analytic modules, complexity of analytic modules requested, number of client users (“logins”), number of clients.

It is one object of the current invention to disclose a simulation project creation module, said module comprising:
a) a plurality of computers communicating over a network;
b) a computer readable medium comprising one or more functional modules including
   i) a database for storing clients' and analysts' data;
   ii) a registration module for registering clients and user analysts in said database;
   iii) an automatic recruitment module for contacting said user analysts; and
   iv) a database of simulations options;
wherein the modules are distributed among said computers, and said modules are configured to execute a method for collaboratively developing said documents; further wherein said collaboration is according to options selected from said simulation options.

It is another object of the current invention, to disclose the simulation project as described above, wherein the simulations options are “plug and play” allowing all possible permutation of said simulation to be stored in said computer readable medium.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 describes a crowdsourced management system;

FIG. 2 shows a flow chart of a method for collaboratively developing documents;

FIG. 3 illustrates analyst metadata information;

FIG. 4 shows an analyst selection module and its input/output; and

FIG. 5 describes an iterative analysts selection process.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

The following provides means and methods of registration for assembly of teams to provide optimum composition of talent and skills to perform a given project, grading mechanisms, and methods for mobilizing large networks of individuals for producing targeted documents.

It is an object of the present invention to disclose a crowdsourced management system for development of a set of content documents, the system comprising:

a) a plurality of computers communicating over a network;
b) a computer readable medium comprising one or more functional modules including
i. a database for storing clients' and analysts' data;
ii. a registration module for registering clients and user analysts in the database; and
iii. an automatic communication module for contacting the user analysts; wherein the modules are distributed among the computers, the modules configured to execute a method for collaboratively developing the documents;
   wherein said modules execute said method comprising steps of: displaying on the computers pre-defined templates that assist corresponding user analysts of each of the computers to formulate candidate documents on the corresponding computers; displaying on each of the computers all the candidate documents formulated on all the computers, each formulated document being displayed on a separate page on each of the computers; receiving, on the computers, information from the corresponding user analysts of the computers, the information is for performing at least one of: commenting on a document displayed on the corresponding computer, and amending a document displayed on the corresponding computer; wherein the information received on one of the computers affects an associated document on all the computers; accumulating scores for each of the documents based upon the comments; and displaying summary information on the computers reflecting the scores, the scores ranking the candidate documents.

The term “computer readable medium” refers hereinafter to any medium that is capable of storing or encoding a sequence of instructions for execution by a computer and that causes the computer to perform any one of the methodologies of the present invention. Said “computer readable medium” includes, but is not limited to, solid-state memories, optical and magnetic disks, and carrier wave signals.

The term “crowdsourcing” refers hereinafter to any process that involves giving tasks to a distributed group of people.

The term “gamification” refers hereinafter to any use of game elements or design in a non-game context.

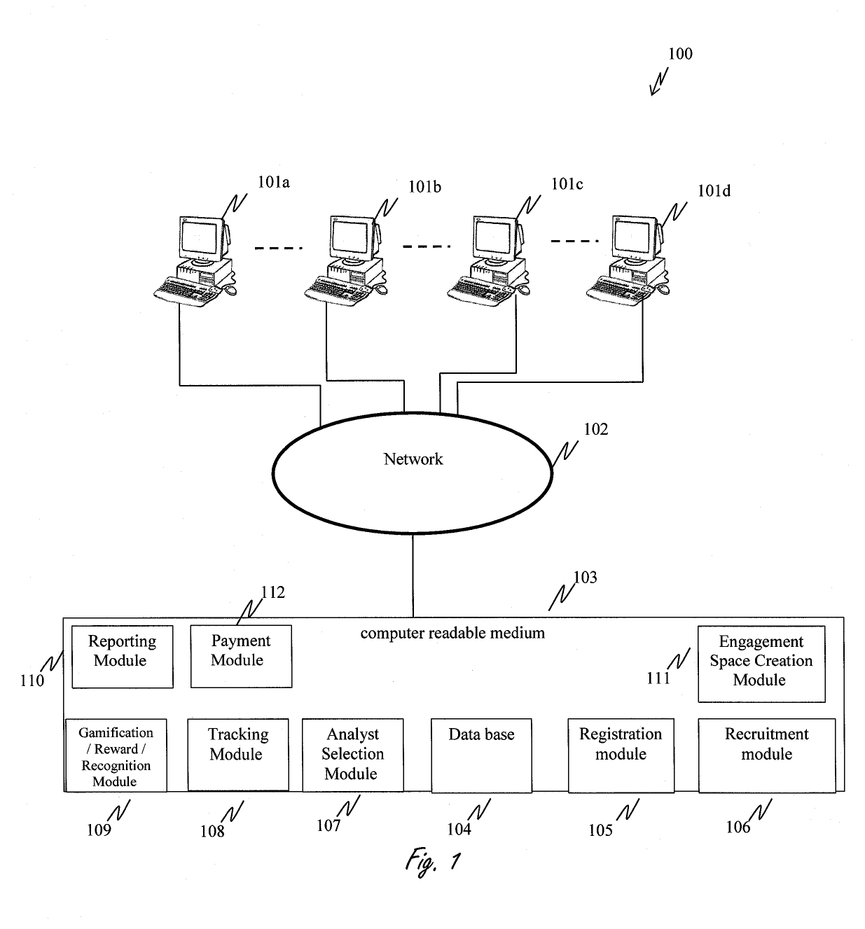

Reference is now made to FIG. 1 which describes in a non-limiting manner a crowdsourced management system 100 for development of a set of content documents, the system 100 comprising:
a) a plurality of computers 101 (a)-(d) communicating over a network 102;
b) a computer readable medium 103 comprising one or more functional modules including
   i) a database 104 for storing clients' and analysts' data;
   ii) a registration module 105 for registering clients and user analysts in the database;
   iii) an automatic recruitment module 106 for contacting the user analysts and inviting them to engagements/projects;
   iv) an analyst selection module 107 for functionally sorting user analysts into optimal groups or team configurations;
   v) a tracking module 108 for detecting and estimating the analysts' contributions;
   vi) a gamification/reward/recognition module 109 for processing said tracking data and providing a game mechanism to the user analyst;
   vii) a reporting module 110 for generating, charting and collecting data from the gamification/reward/recognition module 109 into reports;
   viii) an engagement space creation module 111 for receiving predetermined engagement parameters from the clients, linking the predetermined engagement parameters with the analysts and securing security permissions and;
   ix) a payment module 112 for transmitting payment to the analysts by multiple payment services, on an automatic, semi-automatic and manual basis;
      wherein the modules are distributed among the computers and the modules are configured to execute a method for collaboratively developing the documents.

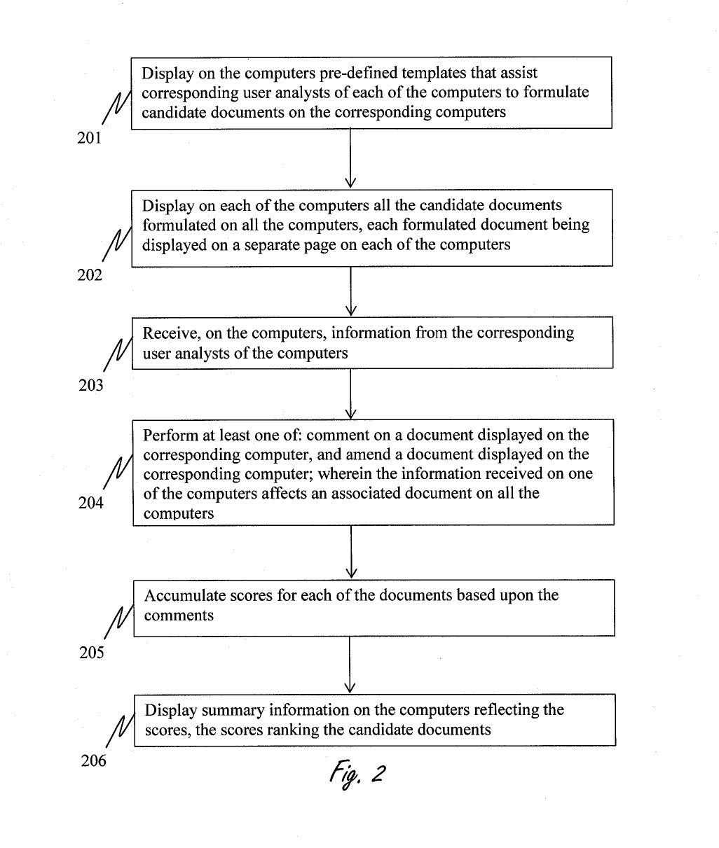

Reference is now made to FIG. 2 which illustrates in a non-limiting manner the above method comprising steps of:
Step 201: display on the computers pre-defined templates that assist corresponding user analysts of each of the computers to formulate candidate documents on the corresponding computers;
Step 202: display on each of the computers all the candidate documents formulated on all the computers, each formulated document being displayed on a separate page on each of the computers;
Step 203: receive, on the computers, information from the corresponding user analysts of the computers,
Step 204 perform, for the information, at least one of: comment on a document displayed on the corresponding computer, and amend a document displayed on the corresponding computer; wherein the information received on one of the computers affects an associated document on all the computers;
Step 205: accumulate scores for each of the documents based upon the comments; and
Step 206: display summary information on the computers reflecting the scores, the scores ranking the candidate documents.

In some embodiments of the current invention, the system 100 as defined above, wherein the database is adapted for storing the analysts' metadata.

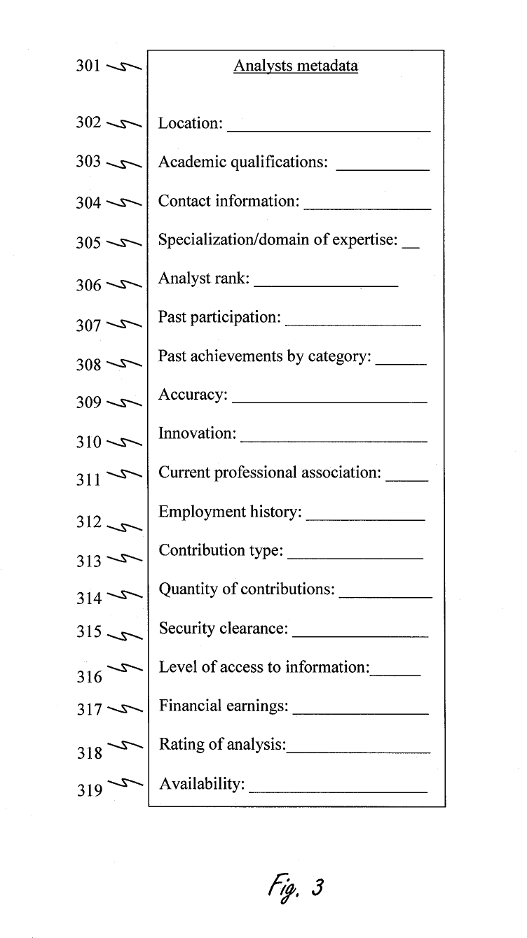

Reference is now made to FIG. 3, which illustrates in a non-limiting manner the analysts' metadata 301, which may be selected from a group consisting, for example, of location 302, academic qualifications 303, contact information 304, specialization/domains of expertise 305, analyst rank 306, past participation 307, past achievements by category 308, accuracy 309, innovation 310, current professional association 311, employment history 312, contribution type 313, quantity of contributions 314, security clearance 315, levels of access to information 316, financial earnings 317, rating of analysis 318, and availability 319.

In some embodiments of the current invention, the system 100 as defined above additionally includes registration and recruitment modules adapted for dynamically updating the data base based on crowdsourcing.

In some embodiments of the current invention, the system 100 as defined above, wherein the computer readable medium comprises a ranking module adapted for ranking the analysts according to predetermined variables, and updated during and after a specific engagement.

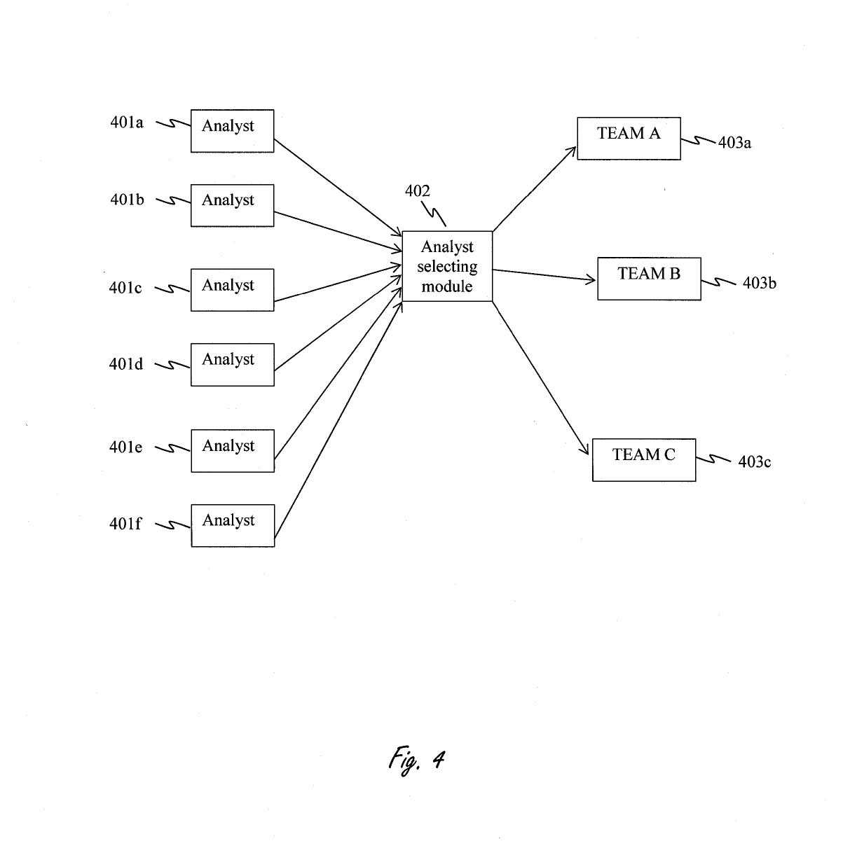

Reference is now made to FIG. 4, which shows in a non-limiting manner the system as defined above, additionally comprising an analyst selection module 402 adapted for functionally selecting user analysts 401 (a)-(f) into the optimal configuration of groups 403(a)-(c), and further adapted for proposing alternative backup teams, prioritized lists of teams or any other conventional alternative combination.

In some embodiments of the current invention, the system 100 as defined above, wherein the analyst selection module is based on client request (engagement attributes) matched against analyst metadata and any combination thereof.

In some embodiments of the current invention, the system 100 as defined above, wherein the analyst selection module is further adapted to receive sets of desired capabilities, skillsets, number of analysts required and their ranks, and yields an optimal team composition for an engagement,

In some embodiments of the current invention, the system 100 as defined above, wherein the computer readable medium additionally comprises a tracking module adapted for watching analysts' contributions and how both clients and analysts interact or rate each other to make determinations as to quality and relevance.

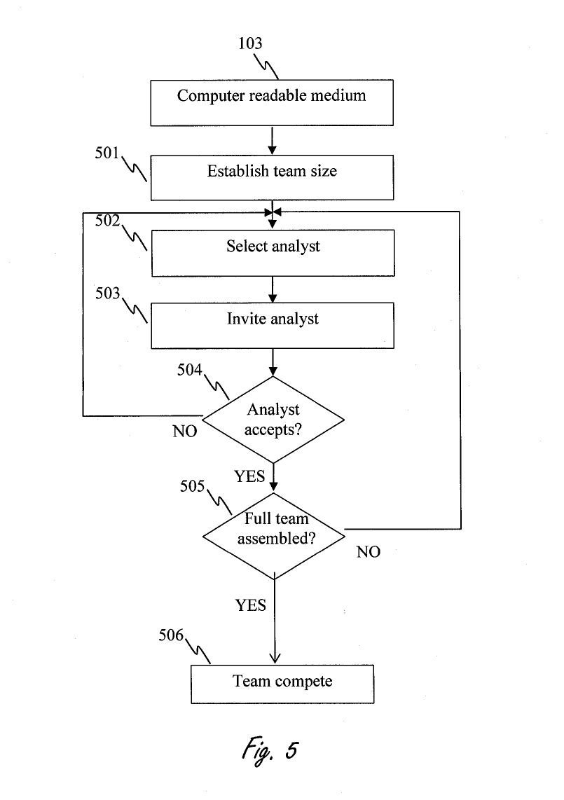

Reference is now made to FIG. 5, which illustrates in a non-limiting manner the computer readable medium 103 comprising a recruitment module adapted for automatically inviting analysts to an engagement, for tracking whether they accept or decline, and for sending additional invitations to replace those who decline. In some embodiments of the module, the team size is established (501) and an analyst is selected to be a member of the team (502). An invitation is sent to the analyst (503). If the analyst declines the invitation (504), a new analyst is selected (502). If the analyst accepts (504), the system checks whether sufficient analysts have accepted (505) to form the team. If not, another analyst is selected (502). If so, the team is complete (506).

In some embodiments of the current invention, the system 100 as defined above, wherein the system 100 additionally comprises a gamification/reward/recognition module adapted for processing said tracking data and to provide game mechanics to said user analyst.

In some embodiments of the current invention, the system 100 as defined above, wherein the game mechanics comprises accumulation of points for said analyst interactions, for example editing pages, commenting, creating pages, recruitment of new users/analysts completing a project, securing a client, getting media mentions for the network, interacting with other users/analysts.

In some embodiments of the current invention, the system 100 as defined above, wherein the game mechanics further comprises a marker of achievements for indicating passing a specific point and/or contribution and/or milestone.

In some embodiments of the current invention, the system 100 as defined above wherein the gamification/reward/recognition module is configured to display said accumulating points and/or said marker of achievements in profiles, scoreboards and leaderboard formats via boards by group, boards by rank and/or boards by level or any other conventional displaying system.

In some embodiments of the current invention, the system 100 as defined above wherein the gamification/reward/recognition module is further configured to notify said analysts about their achievements by internet computer network, intra net computer network, email, SMS, and any other conventional messaging system.

In some embodiments of the current invention, the system 100 as defined above, wherein the gamification/reward/recognition module is further configured for displaying a “flash on screen” encouragement on said analysts' screens in live response to their contribution achievements.

In some embodiments of the current invention, the system 100 as defined above, wherein the gamification/reward/recognition module is further configured to enable said analysts to compete in competitions both core and ancillary to their engagements by exchanging work in return for the opportunity to earn and/or win cash prizes and or any other conventional rewards.

In some embodiments of the current invention, the system 100 as defined above, wherein the gamification/reward/recognition module is further configured to enable rapid mobilization and incentivization contribution of said analysts.

In some embodiments of the current invention, the system 100 as defined above, wherein the system 100 further comprises a reporting module adapted for any of the group consisting of aggregation, charting, collation of data from other modules of said system into reports.

In some embodiments of the current invention, the system 100 as defined above, wherein the reports, illustrated in a non-limiting manner, are selected from a group consisting of (a) timely reports on levels and frequency of participation by all said user analysts, user analyst groups or individual user analysts; (b) timely reports on levels and frequency of participation within specific engagements, pages, page groups; (c) red flagging of user analysts who don't login, contribute, or who fail to conduct certain actions (d) failed login attempts; (e) highest rating viewing/editing user analysts and; (f) multi-IP user analyst logins and any other conventional reports.

In some embodiments of the current invention, the system 100 as defined above, wherein the system 100 further comprises an engagement space creation module adapted for taking parameters for the engagement from a client to create the necessary content placeholders, linking them together and setting up security permissions. Thereby, as said analysts create new content, they can ensure that new information is stored into the correct locations automatically.

In some embodiments of the current invention, the system 100 as defined above, wherein the computer readable medium further comprises a module adapted for iteratively storing analyst created content in real time.

In some embodiments of the current invention, the system 100 as defined above, wherein the computer readable medium further comprises a module adapted for iteratively merging analyst created content in real time.

In some embodiments of the current invention, the system 100 as defined above, wherein the computer readable medium further comprises an editing module adapted for iteratively editing said set of content documents in real time.

In some embodiments of the current invention, the system 100 as defined above, wherein the system further comprises a payment module for transmitting payment and/or any other physical item to said analysts, when earned, by multiple payment services, on an automatic, semi-automatic and manual basis.

In some embodiments of the current invention, the system 100 as defined above, wherein the system further comprises a remuneration module for calculating user analyst rewards.

In some embodiments of the current invention, the system 100 as defined above, wherein the rewards, which are illustrated in a non-limiting manner, are selected from a group consisting of (a) virtual points (as outlined under gamification module)—there could be multiple types of points, as a reward for different types of actions (editing point, recruitment point, bonus point etc); (b) badges and virtual achievements; (c) physical prizes—books and the like; (d) cash prizes—provided on a timely basis and distributed between top performing user analysts; (e) revenue split—user analysts receive a share, as determined based on the factors below, of the revenues from a given project; (f) royalties—user analysts may receive further payment when a project they participated in is sold to additional clients; (g) commission—for enlisting new clients, which is typically either a percentage of a client engagement or a fixed number.

In some embodiments of the current invention, the system 100 as defined above, wherein the rewards, which are illustrated in a non-limiting manner, are calculated using multiple factors and complexities.

In some embodiments of the current invention, the system 100 as defined above, wherein the factors are selected from a group consisting of (a) analyst rank; (b) analyst past performance evaluation; (c) analyst accumulated number of points, or point combinations; (d) number of hours required by the analyst (e) number of analytic modules the user analyst participates in; (f) complexity of analytic modules the user analyst participates in (g) number of direct client interactions required between the user analyst and the client.

In some embodiments of the current invention, the system 100 as defined above, wherein the system further comprises a pricing module for determining the price for client engagements.

In some embodiments of the current invention, the system 100 as defined above, wherein the price, which is illustrated in a non-limiting manner, is determined using multiple factors selected from a group consisting of (a) number of analysts participating; (b) rank of each participating analyst; (c) number and quality of external analysts requested; (d) number of hours required of each analyst in the project; (e) number of analytic modules requested; (f) length of analytic modules; (g) complexity of analytic modules requested; (h) number of client users (“log ins”); (i) number of client-analyst interactions allowed per client or per client user.

In some embodiments of the current invention, the system 100 as defined above, wherein the computer readable medium contains instructions for the implementation of at least one algorithm selected from the group consisting of general combinatorial algorithms, graph algorithms, graph drawing, network theory, routing, and search.

In some embodiments of the current invention, the system 100 as defined above, wherein said at least one algorithm is selected from the group consisting of Brent's algorithm for finding cycles in iterations using only two iterators, Floyd's cycle-finding algorithm for finding cycles in iterations, Gale-Shapley algorithm for matching Pseudorandom number generators (uniformly distributed), Blum Blum Shub algorithm, Lagged Fibonacci generator, Linear congruential generator, and Mersenne twister.

In some embodiments of the current invention, a plurality of computers 101(a)-(d) are connected via a network 102, some of the computers are registered in a data base 104 (via the registration module 105) as experts, and some are just seekers. One of the computers 101(a)-(d) may raise a question, or a request for expert opinion using predefined templates. The analysts then respond to the request and are graded according to their response using different predetermined criteria. In the case where certain analysts refuse the request, the computer readable medium 103 is adapted to re-search other analysts until a proper one is found. Information is exchanged between different computers 101(a)-(d), and scores are given for the experts and for the formed document.

Reference is now made to a gamification system for development of a set of content documents wherein the system is a first system and is in communication with at least one other second system contextually distinguishable from the aforementioned gamification system. The second system is architecturally congruent with the first system.

In some embodiments of the current invention, the system as described above, additionally comprising a rewarding clients/subscribers module. The rewarding may be done via points, ranks, levels, non-monetary rewards (access to additional content), monetary rewards (prize pool).

In some embodiments of the current invention, the system as described above, additionally comprising an incentive mechanism, for the purpose of getting clients/subscribers involved/interacting with the project/consulting engagement, and participating in the project/simulation. In some embodiments of the current invention, the system as described above, additionally comprising a Virtual rewards (such as points) are stored on a separate system to the crowed sourced system used for the user/analysts, so the client can compete internally (between its multiple staff members).

Gamification system (hereby called GS) is a system all on its own. Authorised entities (such as the wiki) notify GS when it has detected an event which may merit a reward. The system considers this information and then informs the entity if the event has triggered an award. GS can also send out its own notifications. This allows multiple disparate systems (for analysts, clients etc) to maintain centralised user reward and persist user information even if one of those systems is shut down.

An Example:

1. Wiki informs GS that a user called ‘bob’ has edited a page making 100 characters of changes.
2. GS calculates that Bob now has 3 new points for a total of 102 points and replies with this information to the Wiki so it can display this to the user.
3. GS calculates that Bob, having crossed the level 3 threshold has earned an achievement and sends its own congratulations email.
4. The Wiki is no longer needed and is shut down.
5. Bob logs onto a different system weeks later and can see that he has 102 points and an achievement for points editing.
6. Bob edits a page and thus the loop repeats.

### 3. Simulation/Project Creation Module

In some embodiments of the current invention, the system as described above, additionally comprising a simulation/project (hereafter “simulation”) module which requires editing sometimes dozens of pages and preparing a similar number of templates which must be structured according to the clients needs. Additionally users are often required to add additional information to ensure the system files and categorizes their information correctly.

“Plug and play” simulations and projects allows for all the possible permutations of a simulation to be known by the system and then a series of simple decisions to be presented to the user from which the system can calculate which pages are needed, what modifications should be made, what templates built and creates everything programmatically.

The same system can be used when a user is contributing content to the system in which the system prompts them with a series of questions about their content (BEFORE THEY START EDITING) and prepares the content to ensure that any functional/routine components of the page are already completed.

Optionally the system can parse the page after it has been complete to look for keywords such as country names, political organizations, etc. . . . and offer the user additional categorization in which they simply need to tick the assumptions that the system has correctly made and the necessary changes or updates will be automatically made.

### Example 1

An event in the real world occurs which is of interest to a particular client. The client immediately requests a strategic report to be provided within hours or days from the occurrence of the aforementioned event.

A client requests a simulation concerning forecasts of the political, security or economic aspects of a particular country in the light of a recent event. The simulation is requested from the provider of the system herein described for crowdsourced collaborative development of a set of content documents.

The client provides, inter alia, data concerning the work order engagement comprising, for example,

1. Starting dates, milestones, and deadlines for the specific project
2. A budget for the engagement
3. The subject matter or theme of interest (i.e. politics, economics)
4. The countries or regions for which analysis is required
5. Specific requests for preferred analysts or preferred analysts' attributes
6. Other data as appropriate.

These needs are fed into the analyst management system within minutes. The system algorithmically evaluates both the client's needs and a series of predefined rules for what would make for a good balance of analysts (level, expertise, availability and the like) and a successful engagement. From this the system is able to:

1. Determine appropriate analysts to invite so to create a balanced and optimal team or teams for the engagement.
2. Email or SMS potential analysts and track if they reply that they are available or unavailable and invite replacements should people decline.
3. Prepare the analytic workspace for the engagement
4. Report on the status of an engagement
5. Provide live updates to both the client and the system operator as to the status of the engagement, outputs so far, levels of participation and other milestones.
5. Update the metadata of all analysts who were affected by this process.
6. Reward participating analysts according to their performance and/or predetermined attributes.

The assembling of teams and their deployment and mobilization can take place within a few hours, and the entire engagement can take as little as hours or few days, depending on the engagement's complexity

### Example 2

Expert analyst A is a potential analyst for joining an analyst-group, analyst network or a particular engagement. A colleague inside the platform/network submits his details as a potentially suitable candidate and analyst. A is emailed suggesting that he clicks a link and apply/register.

Analyst A clicks the link and fills out a form to provide initial metadata to the platform. Analyst A is then put into a holding queue whilst his expertise and relevance are verified. Following this semi-automatic vetting process, Analyst A is then emailed access credentials to the platform, details of his assigned desk/team and suggestions for projects to which he can begin contributing.

Analyst A starts using the system, earning different types of points and badges related to the nature of his contributions. The analyst continues to work and at one point wins a cash prize.

Eventually the system determines that the analyst should be part of the analytic team for a commissioned engagement and emails the analyst the opportunity to take part. Analyst A then clicks accept and a new part of the platform is immediately unlocked for him/her to work.

The engagement takes place, and the analyst continues to be recognized by the system. Eventually the analyst sees the engagement closed and his/her bank account credited with the fee determined by the system. The analyst also notes that his/her standings in the leaderboards are much higher and invitations to engagements start coming more frequently. The analyst submits the name and email address of a colleague who he thinks would make a good fit for the platform/analyst network and the cycle continues.

It will be appreciated by persons skilled in the art that embodiment of the invention are not limited by what has been particularly shown and described hereinabove. Rather the scope of at least one embodiment of the invention is defined by the claims below.

1-46. (canceled)

47. A crowdsourced management system for development of a set of content documents, said system comprising:
a) a plurality of computers communicating over a network;
b) a computer readable medium comprising one or more functional modules including
i) a database for storing clients' and analysts' data;
ii) a registration module for registering clients and user analysts in said database; and
iii) an automatic recruitment module for contacting said user analysts;
wherein the modules are distributed among said computers, and said modules are configured to execute a method for collaboratively developing said documents.

48. The system according to claim 47, wherein said modules execute said method comprising steps of:
a) displaying on said computers pre-defined templates that assist corresponding user analysts of each of said computers to formulate candidate documents on said corresponding computers;
b) displaying on each of said computers all the candidate documents formulated on all said computers, each said formulated document being displayed on a separate page on each of said computers; and
c) receiving, on said computers, information from said corresponding user analysts of said computers, said information is for performing at least one of: commenting on a document displayed on the corresponding computer, and amending a document displayed on said corresponding computer;
wherein said information received on one of said computers affects an associated document on all said computers; accumulating scores for each of the documents based upon said comments; and displaying summary information on said computers reflecting the scores, said scores ranking said candidate documents.

49. The system according to claim 47, wherein said database is adapted for storing said analysts' metadata, and said analysts' metadata is selected from a group consisting of location, academic qualifications, contact information (address, phone, e-mail and the like) specialization and domains of expertise, analyst rank, past participation, past achievements by category, accuracy, innovation, current professional association, employment history (including conflict of interest), contribution type, quantity of contributions, security clearance, levels of access to information, financial earnings, rating of analysis, availability or any combination thereof.

50. The system according to claim 47, wherein said computer readable medium further comprises a ranking module adapted for ranking said analysts according to predetermined variables, updated during and after specific engagement.

51. The system according to claim 47, wherein said recruitment module is further adapted for automatically inviting said analysts to an engagement and tracking whether they accept or decline, and sending additional invitations to replace those analysts who decline.

52. The system according to claim 47, wherein said registration and recruitment modules are adapted for automatically processing potential new analysts either by lead (emailing them) or by application, and then registering them in the system based on crowdsourcing.

53. The system according to claim 47, wherein said computer readable medium further comprises an analyst selection module adapted for:
a) functionally sorting user analysts into optimal groups or team configurations;
b) propose alternative backup teams, prioritized lists of teams or any other conventional alternative combination;
c) said selecting of user analysts is based on client requests (engagement attributes), analyst metadata, client requests engagement attributes matched against analyst metadata, and any combination thereof; and
d) receive sets of desired capabilities, skillsets, budget, number of analysts required and their ranks, and yields an optimal team composition for an engagement

54. The system according to claim 47, wherein said computer readable medium further comprises a tracking module for storing and monitoring analyst contributions by type, quantity, and quality; said tracking module is further configured for monitoring both said clients' and said analysts' interactions and rating the contributions for determining the quality and relevance of said analysts' participation.

55. The system according to claim 47, wherein said system additionally comprises a metadata store.

56. The system according to claim 47, wherein said system additionally comprises:
a) a gamification, reward and recognition module configured to process said monitored participation data and to provide game mechanics comprising accumulation of points for said analyst interactions, to incentivize and mobilize said user analyst;
b) said game mechanics further comprise a marker of achievements for indicating passing a specific point, contribution and milestone;
c) said g gamification, reward and recognition module is configured to display said accumulating points and said marker of achievements in profiles, scoreboards and leader board formats via boards by group, boards by rank and boards by level and any other conventional displaying system;
d) said gamification, reward and recognition module is further configured to notify said analysts about their achievements by internet computer network, intra net computer network, email, SMS, and any other conventional messaging system.
e) said gamification, reward and recognition module is further configured for displaying a “flash on screen” encouragement on said analysts' screens in live response to their contribution achievements.
f) said gamification, reward and recognition module is further configured to enable said analysts to compete in competitions both core and ancillary to their engagements by exchanging work in return for the opportunity to earn and win cash prizes and any other conventional rewards.
g) said gamification, reward and recognition module is further configured to enable a rapid mobilization and incentivization of the contribution of said analysts.

57. The system according to claim 54, wherein said interactions are selected from a group consisting of editing pages, commenting, creating pages, recruitment of analysts, completing projects, securing clients, and getting media mentions for the network.

58. The system according to claim 47, wherein said tracking module is linked to said metadata store and said gamification, reward and recognition module.

59. The system according to claim 47, wherein said system further comprises a reporting module adapted for any of a group consisting of aggregation, charting, and collation of data from other modules of said system into reports; said reports are selected from a group consisting of (a) timely reports on levels and frequency of participation by all said user analysts, user analyst groups and individual user analysts; (b) timely reports on levels and frequency of participation within specific engagements, pages, and page groups; (c) red flagging of user analysts who don't login, contribute, or who fail to conduct certain actions; (d) failed login attempts; (e) highest rating viewing and editing user analysts and (f) multi-IP user analyst logins.

60. The system according to claim 47, wherein said computer readable medium further comprises:
a) a module adapted for iteratively storing analyst created content in real time;
b) a module adapted for iteratively merging analyst created content in real time;
c) an editing module adapted for iteratively editing said set of content documents in real time;
d) a remuneration module adapted for calculating a user analyst's rewards:
i) said user analyst's rewards are selected from a group consisting of: virtual points, badges and virtual achievements, physical prizes, cash prizes, revenue split, royalties, commission and any other conventional rewards known in the art;
ii) said rewards are calculated using multiple factors and complexities;
iii) said factors are selected from a group consisting of: analyst rank, analyst past performance evaluation, analyst accumulated number of points, or point combinations, number of hours required of conducted by the analyst, number of analytic modules the user analyst participates in, complexity of analytic modules the user analyst participates in, number of direct client interactions required between the user analyst and the client;
e) a pricing module adapted for determining the price for client engagements:
i) said price is configured to be determined using multiple factors and complexities;
ii) said factors are selected from a group consisting of: number of analysts participating, rank of each participating analyst, number and quality of external analysts requested, number of hours required of each analyst in the project, number of analytic modules requested, length of analytic modules, complexity of analytic modules requested, number of client users, logins, and number of clients; and
f) instructions for the implementation of at least one algorithm selected from a group consisting of general combinatorial algorithms, graph algorithms, graph drawing, network theory, routing, and search:
i) said at least one algorithm is selected from the group consisting of Brent's algorithm for finding cycles in iterations using only two iterators, Floyd's cycle-finding algorithm for finding cycles in iterations, Gale-Shapley algorithm for matching pseudorandom number generators (uniformly distributed), Blum Blum Shub algorithm, lagged Fibonacci generator, linear congruential generator, and Mersenne twister.
g) a payment module for transmitting payment and any other physical item to said analysts, when earned, by multiple payment services, on an automatic, semi-automatic and manual basis.

61. The system according to claim 47, additionally comprising a module for rewarding either one of said clients, said analysts and said users, with a reward selected from a group comprising of: points, ranks, levels, non-monetary rewards, access to additional content, monetary rewards, prize pool, and a combination thereof.

62. The system according to claim 47, wherein said system is a first system and is in communication with at least one other second system contextually distinguishable from said first system of claim one; said second system is architecturally congruent with said first system of claim 1.

63. The system according to claim 62, wherein said at least one system alerts another system on detection of a relevant event.

64. The system according to claim 47, wherein said system additionally comprises a simulation-project creation module.

65. A simulation project creation module, said module comprising:
a) a plurality of computers communicating over a network;
b) a computer readable medium comprising one or more functional modules including
i) a database for storing clients' and analysts' data;
ii) a registration module for registering clients and user analysts in said database;
iii) an automatic recruitment module for contacting said user analysts; and
iv) a database of simulations options;
wherein the modules are distributed among said computers, and said modules are configured to execute a method for collaboratively developing said documents; further wherein said collaboration is according to options selected from said simulation options.

66. The simulation project according to claim 65, wherein said simulations options have a feature that allows all possible permutation of said simulation to be stored in said computer readable medium.
